(19) United States
(12) Patent Application Publication
(10) Pub. No.: US 2003/0116938 A1
(43) Pub. Date: Jun. 26, 2003

(54) Vehicle tailgate step

(76) Inventors: Scott Shields, Tallapoosa, GA (US); James E. Owens, Douglasville, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/357,694

(22) Filed: Feb. 4, 2003

(51) Int. Cl. B60R 3/00

(52) U.S. Cl. 280/166

(57) ABSTRACT

A vehicle tailgate step, wherein the step is pivotally mounted to the rear of a truck/vehicle, proximal the tailgate, and provides accessibility to the truck bed from the side of the truck when the tailgate is in the closed position, or from directly behind the truck, regardless of the tailgate position. Additionally, the device can be selectively manufactured to provide access to the contents of a truck bed from the side of the truck bed when the tailgate is in either a raised or lowered position.

### TECHNICAL FIELD

The present invention relates generally to vehicle steps, and more specifically to a vehicle tailgate step. The present invention is particularly suitable for, although not strictly limited to, assisting an individual access the contents of a pickup truck bed.

### BACKGROUND OF THE INVENTION

Small trucks, commonly referred to as pickup trucks, are typically utilized in the construction industries and/or for residential purposes to transport bulk construction materials and/or other desired supplies and/or articles. Most such small trucks are equipped with tailgates to facilitate the introduction and/or removal of such materials and/or supplies from the truck bed.

Moreover, due to the generally large weight and/or immense mass of construction materials and/or supplies being carried in the truck, most trucks are generally equipped with a raised suspension and/or possess large shock mechanisms to accommodate the weighty loads carried therein. As such, due to the overall heightened elevation of the truck body from the ground, it typically becomes difficult to gain access to the truck bed even when the tailgate has been lowered, and more so when the truck is not loaded. Therefore, to facilitate entry into the truck bed of such raised trucks, many individuals typically utilize the truck bumper and/or factory bumper step to boost themselves into the truck bed and gain access to the contents carried therein. However, such a method often requires more effort than necessary and is usually a physically strenuous task, requiring the vehicle user to physically hoist him/herself into the rear of the truck, chancing bodily injury should he/she lose his/her balance and slip therefrom.

Although leverage devices, or steps, are available for attachment to the rear bumper of a truck, many such devices possess inherent disadvantages that make their use impractical, inefficient and/or problematic. For instance, some commonly available leverage/step mechanisms are typically in the form of a small, single step mountable to the underside of the rear bumper of a truck. Although simplistic in design, such devices are clearly disadvantageous, as they become inaccessible upon lowering of the tailgate, limiting their use to a closed tailgate condition.

To remedy the aforementioned single step device and problems associated therewith, other available devices have incorporated a telescopic step fixedly mounted to the underside of the rear bumper. Such devices, however, are also clearly disadvantageous, as they only permit access to the truck bed from either directly behind the truck or from the side of the truck depending upon how the telescopic step was fixedly attached.

Although truck mounted steps capable of pivoting from one position to another are available, such steps have typically been manufactured to a compact size, making their accessibility difficult when the tailgate has been lowered, thus limiting use of such pivotal steps to a raised tailgate condition only. Furthermore, such available pivotal steps often lack a sufficient locking mechanism to assist in securely locking the pivoted/extended step in a safe and fixed position, subjecting the user of the step to potential injury should he/she slip therefrom.

In general, most available truck steps are functionally limited in the manner in which they attach to the rear bumper of the truck. Specifically, most available devices either possess a mechanism to attach to receiver style hitches only, or must be mounted directly to the underside of the truck factory bumper step, thus circumscribing and/or restrictively defining the specific type and/or style of truck step that may be attached to a specific type or style of truck or truck bumper, diminishing or eliminating any proclaimed universal application of the truck step.

Therefore it is readily apparent there is a need for a vehicle tailgate step, wherein a user of the device is able to easily access contents within a vehicle's truck bed from either directly behind the vehicle when the vehicle's tailgate is either in a raised or lowered position, and from the side of the vehicle's truck bed when the tailgate is in the closed position.

### BRIEF SUMMARY OF THE INVENTION

Briefly described, in a preferred embodiment, the present invention overcomes the above-mentioned disadvantages and meets the recognized need for such a device by providing a vehicle tailgate step, wherein the step is pivotally mounted to the rear of a truck/vehicle, proximal the tailgate, and provides accessibility to the truck bed from the side of the truck when the tailgate is in the closed position, or from directly behind the truck, regardless of the tailgate position. Additionally, the device can be selectively manufactured to provide access to the contents of a truck bed from the side of the truck bed when the tailgate is in either a raised or lowered position.

According to its major aspects and broadly stated, the present invention in its preferred form is a vehicle tailgate step having, in general, a mounting mechanism, extension bar, and step.

More specifically, the present invention is a vehicle tailgate step possessing a mounting mechanism for removably mounting the vehicle tailgate step, or device, to the rear bumper of a vehicle, wherein an extension bar is in pivotal communication therewith, and wherein a step is in communication with the extension bar. The pivotally-actuated extension bar preferably provides user accessibility to the communicating step from directly behind the vehicle when the vehicle's tailgate is either in a raised or lowered position, wherein the extension bar is preferably capable of being securely locked in an extended position.

When the extension bar is in a retracted position, and the tailgate in the closed position, a user of the device can access contents within the vehicle's truck bed by stepping from the ground onto the step of the retracted extension bar, then onto the factory bumper, and thereafter, over the closed tailgate and into the truck bed, thus avoiding conventional methods of having to heave one's self from the ground onto the bumper, and thereafter, over the tailgate and into the vehicle's truck bed. The extension bar is preferably capable of being securely locked in a retracted position.

Additionally, the device can be selectively manufactured to provide access to the contents of a truck bed from the side of the truck bed when the tailgate is in either a raised or lowered position.

A feature and advantage of the present invention is its ability to provide access to the contents of a truck bed from the rear of the truck when the tailgate is in either a raised or lowered position.

A feature and advantage of the present invention is its ability to provide access to the contents of a truck bed from the side of the truck bed when the tailgate is in a raised position by permitting a user of the device to step from the ground onto the retracted step, then onto the factory bumper, and thereafter, over the tailgate and into the vehicle's truck bed.

A feature and advantage of the present invention is its ability to provide access to the contents of a truck bed from the side of the truck bed when the tailgate is in either a raised or lowered position, wherein the step is in a retracted position.

A featured advantage of the present invention is its ability to be modified to possess a downwardly-directed gooseneck formation, such that it decreases overall distance from the bottom of the step to the ground, thus increasing accessibility thereto.

A feature and advantage of the present invention is its pivotal actuation.

A feature and advantage of the present invention is its ability to be adapted/mounted to a standard receiver-style hitch.

A feature and advantage of the present invention is its ability to be adapted/mounted to a standard factory bumper step.

A feature and advantage of the present invention is its ability to be modified to mount to any vehicle including, but not limited to, small trucks, pickup trucks and/or sports utility vehicles.

A feature and advantage of the present invention is its ability to be lockingly secured in an extended or retracted position.

A feature and advantage of the present invention is it durability.

A feature and advantage of the present invention is its ability to accommodate pre-existing rear bumper ball hitches.

A feature and advantage of the present invention is its ability to be modified to pivotally swivel from opposing sides of the rear of the vehicle.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a top view of a vehicle tailgate step according to a preferred embodiment of the present invention;

FIG. 2 is an exploded view of a vehicle tailgate step according to a preferred embodiment of the present invention;

FIG. 3 is a perspective view of a vehicle tailgate step according to a preferred embodiment of the present invention, showing the step in an extended position;

FIG. 4 is a perspective view of a vehicle tailgate step according to a preferred embodiment of the present invention, showing the step in a retracted position;

FIG. 5 is a perspective view of a vehicle tailgate step according to a preferred embodiment of the present invention, showing the step in an extended position and in use;

FIG. 6 is a perspective view of a vehicle tailgate step according to a preferred embodiment of the present invention, showing the step in a retracted position and in use;

FIG. 7 is a top view of a vehicle tailgate step according to an alternate embodiment of the present invention;

FIG. 8 is an exploded view of a vehicle tailgate step according to an alternate embodiment of the present invention;

FIG. 9 is a perspective view of a vehicle tailgate step according to an alternate embodiment of the present invention, showing the step in an extended position;

FIG. 10 is a perspective view of a vehicle tailgate step according to an alternate embodiment of the present invention, showing the step in a retracted position;

FIG. 11 is a perspective view of a vehicle tailgate step according to an alternate embodiment of the present invention, showing the step in an extended position and in use;

FIG. 12 is a perspective view of a vehicle tailgate step according to an alternate embodiment of the present invention, showing the step in a retracted position and in use;

FIG. 13 is a top view of a vehicle tailgate step according to an alternate embodiment of the present invention;

FIG. 14 is an exploded view of a vehicle tailgate step according to an alternate embodiment of the present invention;

FIG. 15 is a perspective view of a vehicle tailgate step according to an alternate embodiment of the present invention, showing the step in an extended position;

FIG. 16 is a perspective view of a vehicle tailgate step according to an alternate embodiment of the present invention, showing the step in a retracted position;

FIG. 17 is a perspective view of a vehicle tailgate step according to an alternate embodiment of the present invention, showing the step in an extended position and in use; and,

FIG. 18 is a perspective view of a vehicle tailgate step according to an alternate embodiment of the present invention, showing the step in a retracted position and in use.

FIG. 19 is a perspective view of a vehicle tailgate step according to an alternate embodiment of the present invention, showing the step in a retracted position and in use;

FIG. 20 is a perspective view of a vehicle tailgate step according to an alternate embodiment of the present invention, showing the step in a retracted position and in use;

FIG. 21 is a perspective view of a vehicle tailgate step according to an alternate embodiment of the present invention, showing the step in a retracted position and in use;

### DETAILED DESCRIPTION OF THE PREFERRED AND ALTERNATIVE EMBODIMENTS

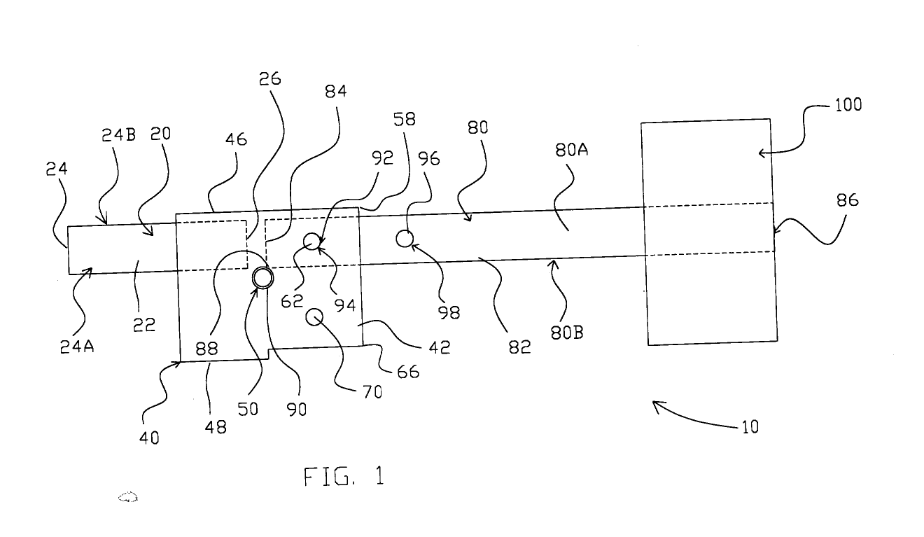

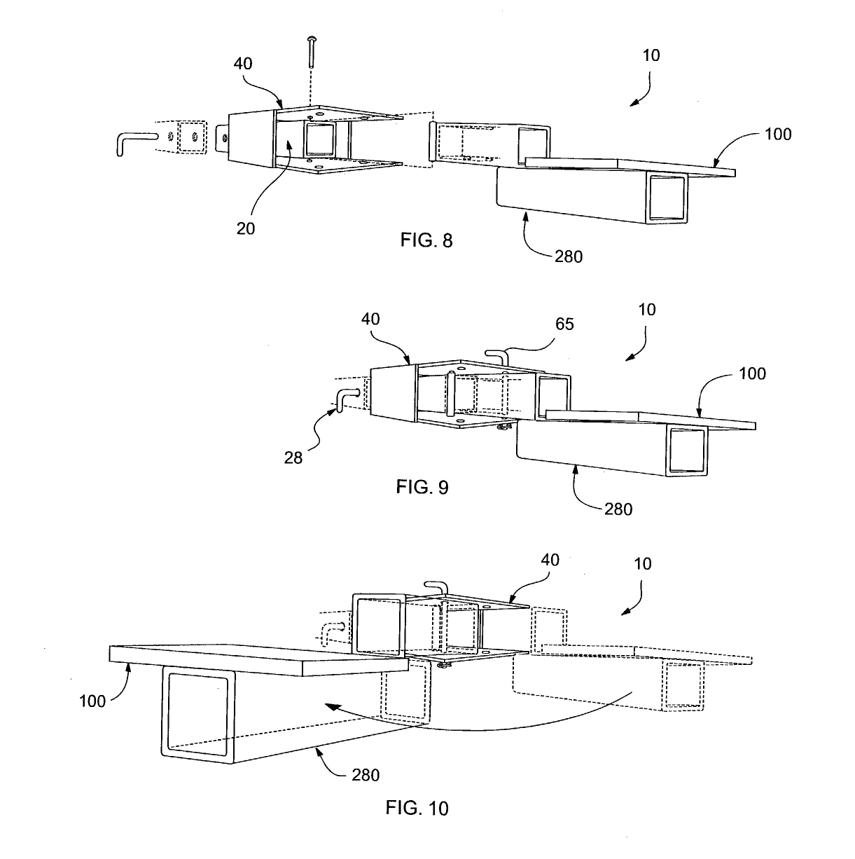

In describing the preferred and alternate embodiments of the present invention, as illustrated in FIGS. 1-21, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, the present invention in a preferred embodiment is a device 10, wherein device 10 is a vehicle tailgate step, having mounting mechanism 20, support plate assembly 40, extension bar 80 and step 100, wherein device 10 is preferably formed from a durable metal; although other suitable materials could be used, such as, for exemplary purposes only, durable plastic.

Mounting mechanism 20 is preferably an elongated, substantially square-shaped mounting tube 22, having first end 24 and second end 26, wherein first end 24 is preferably dimensioned to be received by a standard factory receiver-style hitch A, and removably lockingly secured therein via insertion of pin 28 through first standard hitch throughhole B, through first throughhole 24A and second throughhole 24B formed in alignment through first end 24, and then through second standard hitch throughhole B′.

End 26 of tube 22 is preferably welded to support plate assembly 40 and/or fixedly attached thereto via any suitable attaching means known within the art, such as, for exemplary purposes only, rivets, bolts and/or metal adhesives. Specifically, support plate assembly 40 is substantially rectangular-tube-shaped, having upper plate 42, lower plate 44, first sidewall 46 and second sidewall 48, wherein first sidewall 46 and second sidewall 48 preferably adjoin upper plate 42 and lower plate 44, and wherein first sidewall 46 and second sidewall 48 are preferably substantially shorter in length than the length of upper plate 42 or lower plate 44 so as to permit pivotal movement of extension bar 80 therewithin, as more fully described below. End 26 of tube 22 of mounting mechanism 20 is preferably welded between upper plate 42 and lower plate 44, proximal second sidewall 48, as best illustrated in FIG. 1.

Preferably centrally positioned and formed in alignment through upper plate 42 and lower plate 44 are throughholes 50 and 52, respectively, wherein throughholes 50 and 52 receive rivet 54 therethrough for assisting in the pivotal movement of extension bar 80 therein, as more fully described below. Although rivet 54 is the preferred mechanism in which to assist in the pivotal movement/attachment of extension bar 80, other mechanisms could be utilized such as, for exemplary purposes only, bolts, pins and/or the like.

Extension bar 80 is preferably an elongated, substantially square-shaped tube 82, having first end 84 and second end 86, wherein extension bar 80 further preferably possesses a length sufficient to permit accessibility to attached step 100 when a vehicle's tailgate is in either a raised or lowered position, and to permit accessibility to step 100 when device 10, in general, is in a retracted position, as more fully described below. Preferably, corner 88 of first end 84 of tube 82 has tubular-shaped collar 90 welded thereon and/or fixedly attached thereto via any suitable attaching means known within the art, such as, for exemplary purposes only, metal adhesives. Preferably, upon slidable engagement of first end 84 of extension bar 80 between upper plate 42 and lower plate 44 of support plate assembly 40, collar 90 preferably aligns with throughholes 50 and 52 of upper plate 42 and lower plate 44, respectively, wherein insertion of rivet 54 through throughhole 50, through collar 90, and then through throughhole 52 preferably permits pivotal motion of extension bar 80 therein, and wherein extension bar 80 is secured therein via welding head 56 of rivet 54 to upper plate 42 for secured retention therethrough, and within collar 90. So as to not hinder pivotal movement of extension bar 80 within support plate assembly 40, first sidewall 46 and second sidewall 48 of support plate assembly 40 are preferably substantially shorter in length than the length of upper plate 42 or lower plate 44, thus providing a sufficient clearing for the pivotal movement of extension bar 80.

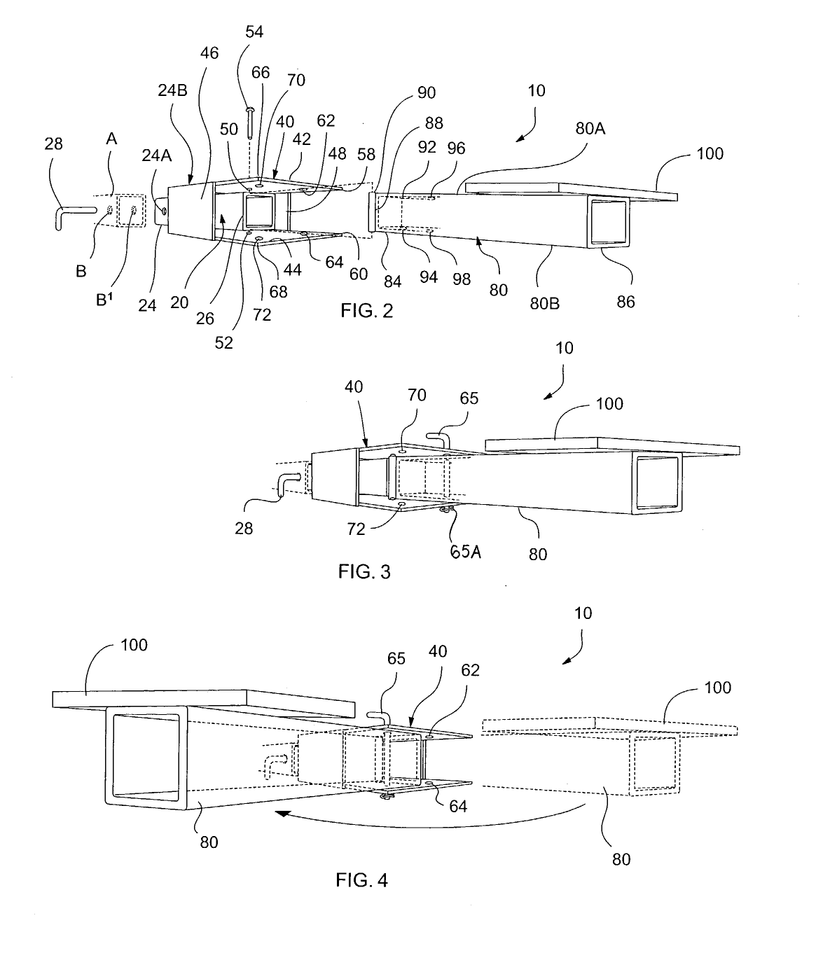

Referring now more specifically to FIGS. 2-4, preferably positioned proximal to and formed in alignment through corners 58 and 60 of upper plate 42 and lower plate 44, respectively, are throughholes 62 and 64, respectively. Throughholes 62 and 64 preferably align with aligned throughholes 92 and 94, respectively, formed through upper surface 80A and lower surface 80B, respectively, of extension bar 80, upon engagement of extension bar 80 with support plate assembly 40, wherein throughholes 92 and 94 are preferably positioned/formed proximal to end 84 of extension bar 80. Preferably, to assist in locking extension bar 80 in an extended position, lock pin 65 is inserted through throughhole 62 of upper plate 42 of support plate assembly 40, through throughhole 92 of upper surface 80A of extension bar 80, through throughhole 94 of lower surface 80B of extension bar 80, and then through throughhole 64 of lower plate 44 of support plate assembly 40, wherein cotter pin 65A retains lock pin 65 therein, as best illustrated in FIG. 3.

Similarly, preferably positioned proximal to and formed in alignment through corners 66 and 68 of upper plate 42 and lower plate 44, respectively, are throughholes 70 and 72, respectively. Throughholes 70 and 72 preferably align with aligned throughholes 96 and 98, respectively, formed through upper surface 80A and lower surface 80B, respectively, of extension bar 80, upon engagement of extension bar 80 with support plate assembly 40, wherein throughholes 96 and 98 are preferably positioned/formed proximal the mid-region of extension bar 80. Preferably, to assist in locking extension bar 80 in a retracted position, lock pin 65 is inserted through throughhole 70 of upper plate 42 of support plate assembly 40, through throughhole 96 of upper surface 80A of extension bar 80, through throughhole 98 of lower surface 80B of extension bar 80, and then through throughhole 72 of lower plate 44 of support plate assembly 40, wherein cotter pin 65A, again, retains lock pin 65 therein, as best illustrated in FIG. 4.

Step 100 is preferably welded to upper surface 80A, proximal second end 86, of extension bar 80, and/or fixedly attached thereto via any suitable attaching means known within the art, such as, for exemplary purposes only, rivets, bolts and/or metal adhesives. Step 100 is preferably substantially rectangular-shaped and preferably possesses a substantially textured or rough surface to provide frictional footing or traction thereon. Due to the extended length of extension bar 80, step 100, of an extended device 10, is accessible from the rear of the vehicle when a vehicle's tailgate is in either a raised or lowered position, and is further accessible when device 10, in general, is in a retracted position, and the vehicle's tailgate closed. However, as more fully detailed below, device 10 could alternatively be manufactured to permit access to retracted step 100 when a vehicle's tailgate is in either the raised or lowered position.

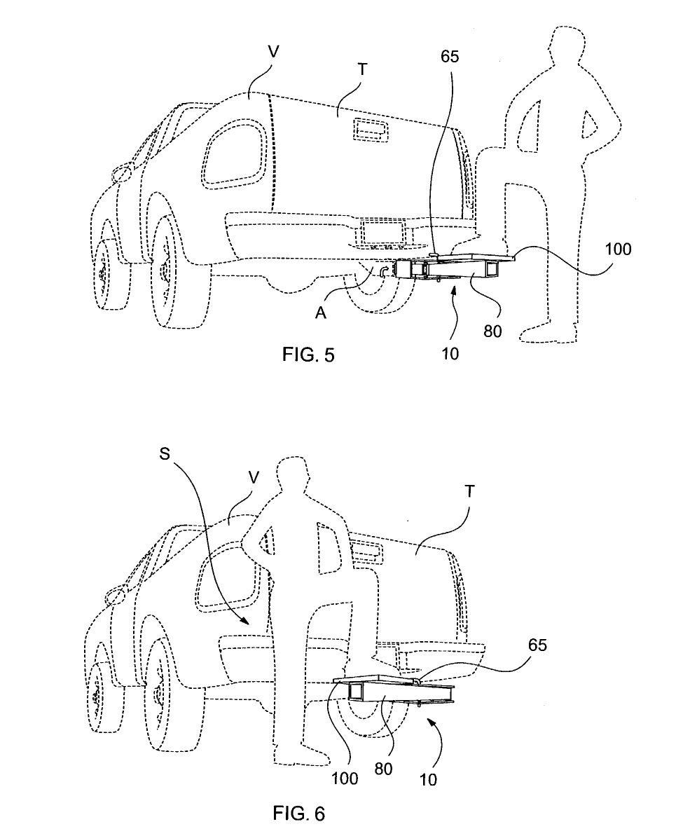

As best illustrated in FIG. 5, device 10 is shown attached to standard receiver-style hitch A of vehicle V, wherein tailgate T is shown in a lowered position. As depicted, extension bar 80 is in an extended position, thus permitting step 100 to extend past the open tailgate T. Extension bar 80 is also shown locked into place, in its extended position, via lock pin 65.

As best illustrated in FIG. 6, device 10 is shown attached to standard receiver-style hitch A of vehicle V, wherein tailgate T is shown in a raised position. As depicted, extension bar 80 is in a retracted position, thus permitting a user of device 10 to step from the ground onto step 100, onto the factory bumper, and thereafter, over tailgate T and into the vehicle's truck bed, thus permitting access thereto from side S of vehicle V. Extension bar 80 is also shown locked into place, in its retracted position, via lock pin 65.

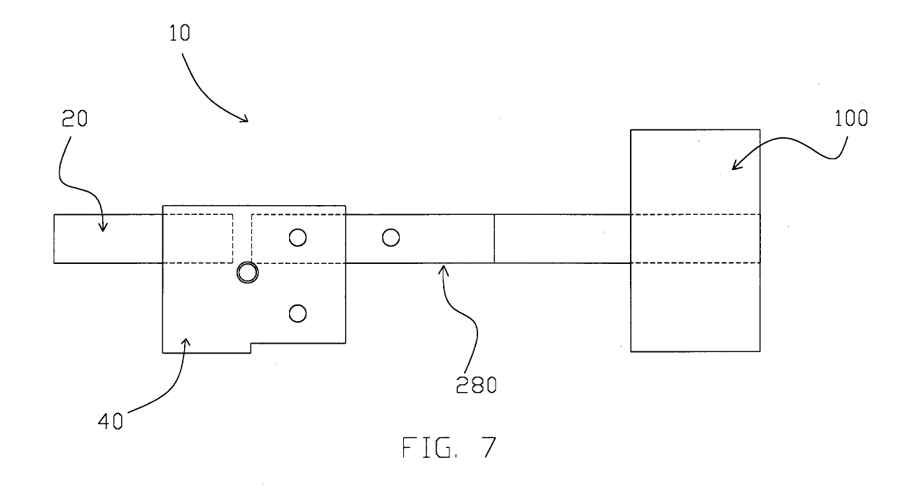

Referring now more specifically to FIGS. 7-12, illustrated therein is an alternate embodiment of device 10, wherein the alternate embodiment of FIGS. 7-12 is substantially equivalent in form and function to that of the preferred embodiment detailed and illustrated in FIGS. 1-6 except as hereinafter specifically referenced. As illustrated, the embodiment of FIGS. 7-12 replaces extension bar 80 with extension bar 280, wherein the present alternate embodiment finds particularly favorable use on vehicles/trucks that have a raised suspension—primarily due to the goose-necked shape of extension bar 280, as more fully described below. Specifically, extension bar 280 is an elongated, substantially square-shaped, downwardly-directed goose-necked tube 282, having first end 284 and second end 286, wherein extension bar 280 further possesses a length sufficient to permit accessibility to attached step 100 when a vehicle's tailgate is in either a raised or lowered position, and to permit accessibility to step 100 when alternate embodiment device 10, in general, is in a retracted position, as more fully described below. Furthermore, due to the substantially goose-necked shape of tube 282, step 100 attached to extension bar 280 is substantially lower to the ground when alternate embodiment device 10 is attached to hitch A, thus affording a user of alternate embodiment device 10 the ability to access the truck bed contents of a vehicle having a raised suspension.

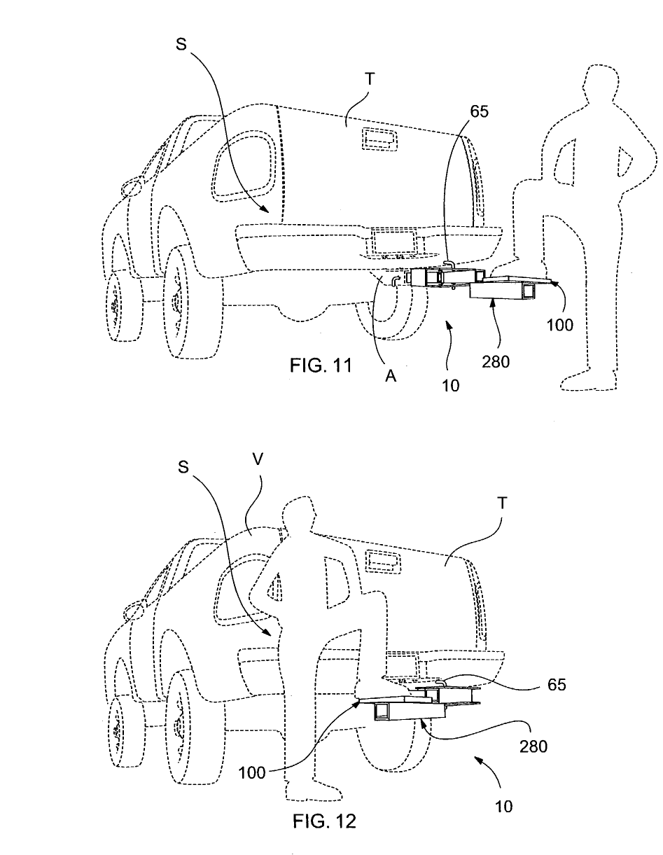

As best illustrated in FIG. 11, alternate embodiment device 10 is shown attached to standard receiver-style hitch A of vehicle V, wherein tailgate T is shown in a lowered position. As depicted, extension bar 280 is in an extended position, thus permitting step 100 to extend past the open tailgate T. Extension bar 280 is also shown locked into place, in its extended position, via lock pin 65.

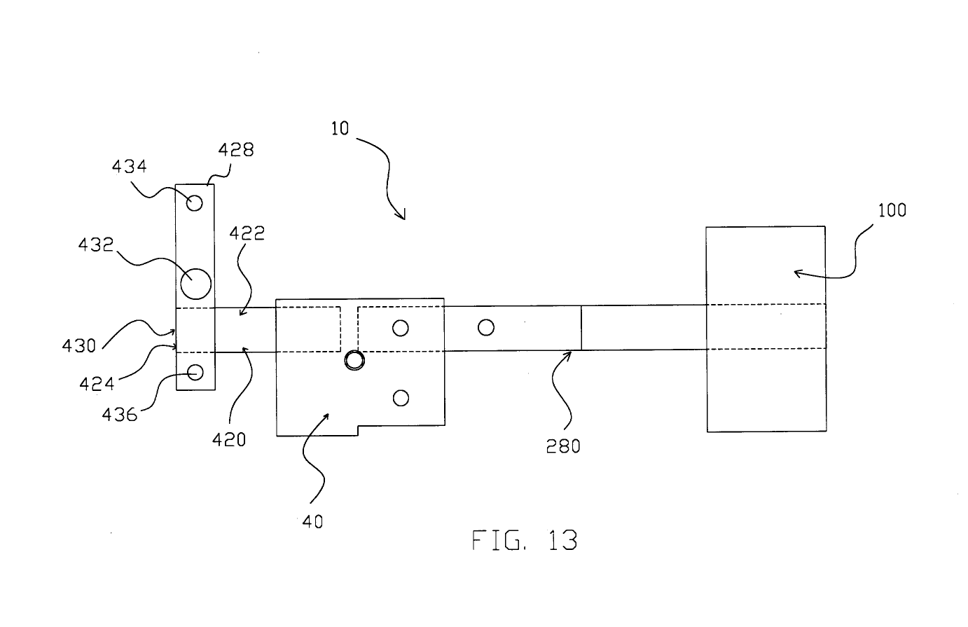

As best illustrated in FIG. 12, alternate embodiment device 10 is shown attached to standard receiver-style hitch A of vehicle V, wherein tailgate T is shown in a raised position. As depicted, extension bar 280 is in a retracted position, thus permitting a user of device 10 to step from the ground onto step 100, onto the factory bumper, and thereafter, over tailgate T and into the vehicle's truck bed, thus permitting access thereto from side S of vehicle V. Extension bar 280 is also shown locked into place, in its retracted position, via lock pin 65.

Referring now more specifically to FIGS. 13-18, illustrated therein is an alternate embodiment of device 10, wherein the alternate embodiment of FIGS. 13-18 is substantially equivalent in form and function to that of the alternate embodiment detailed and illustrated in FIGS. 7-12 except as hereinafter specifically referenced. As illustrated, the embodiment of FIGS. 13-18 replaces mounting mechanism 20 with mounting mechanism 420, wherein the present alternate embodiment of device 10 is particularly suitable for attachment to standard factory bumper steps, as more fully described below. Alternate embodiment device 10 further finds particularly favorable use on vehicles/trucks that have a raised suspension, primarily due to the goose-necked shape of extension bar 280.

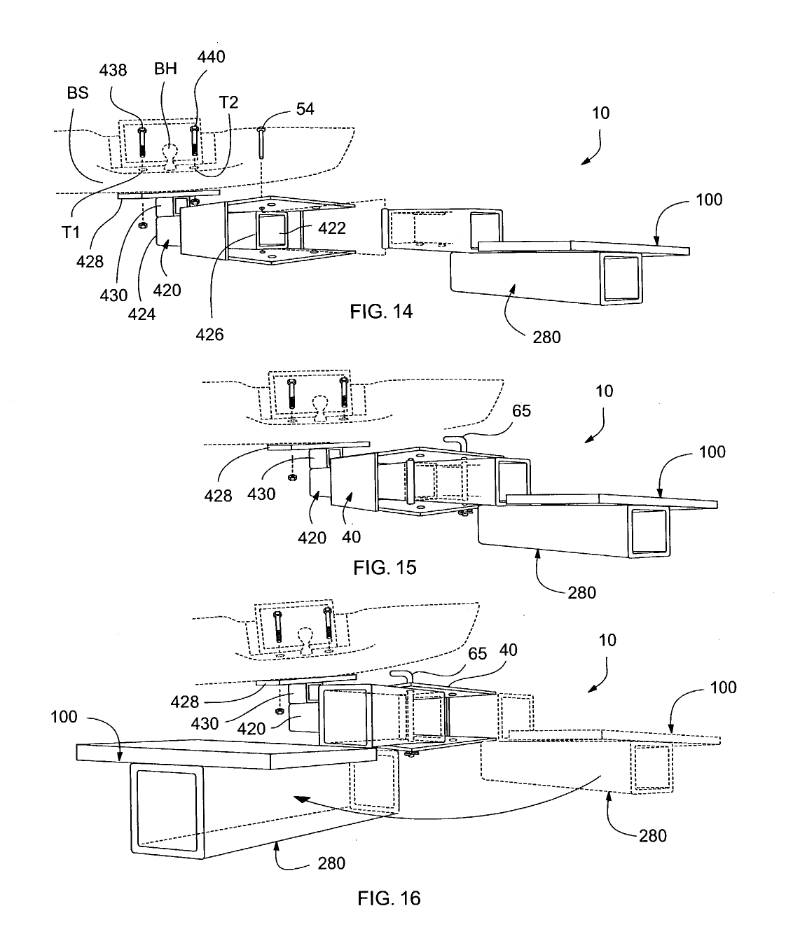

Mounting mechanism 420 possesses an elongated, substantially square-shaped tube 422 having first end 424 and second end 426, and further possesses mounting plate 428 attached thereto. More specifically, mounting plate 428 is welded to an intermediary block 430 that is welded onto upper surface 422A of tube 422, proximal to first end 424, wherein mounting plate 428 is welded to intermediary block 430 such that intermediary block 430 is positioned just below the mid-region of mounting plate 428, as best illustrated in FIG. 13. Mounting plate 428 permits alternate embodiment device 10 to be mounted to the underside of a standard factory bumper step BS. As such, centrally formed through mounting plate 428 is throughhole 432, wherein throughhole 432 is preferably dimensioned to securely receive the threaded portion of conventional ball-hitch BH, as best illustrated in FIG. 14. Flanking throughhole 432 are throughholes 434 and 436, wherein throughholes 434 and 436 align with standard factory throughholes T1 and T2, respectively, of bumper step BS when mounting plate 428 is brought into contact therewith. Throughholes 434 and 436 of mounting plate 428 are dimensioned to receive bolts 438 and 440, respectively, thus securing alternate embodiment device 10 to the underside of bumper step BS, as best illustrated in FIG. 14. As best illustrated in FIG. 13, end 426 of tube 422 of mounting mechanism 420 is welded between upper plate 42 and lower plate 44, proximal second sidewall 48, or fixedly attached thereto via any suitable attaching means known within the art, such as, for exemplary purposes only, rivets, bolts and/or metal adhesives.

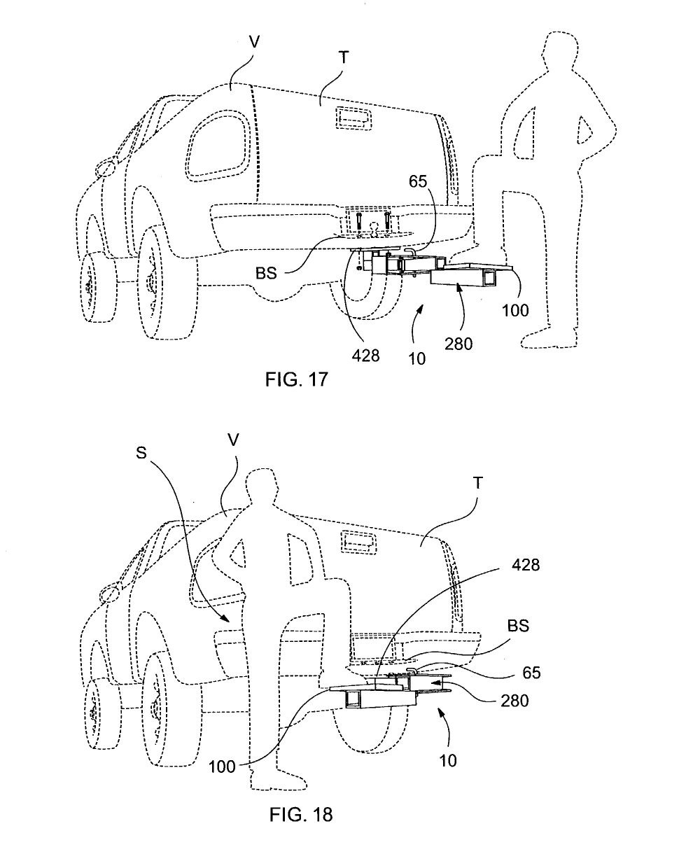

As best illustrated in FIG. 17, alternate embodiment device 10 is shown attached to the underside of standard factory bumper step BS of vehicle V, wherein tailgate T is shown in a lowered position. As depicted, extension bar 280 is in an extended position, thus permitting step 100 to extend past the open tailgate T. Extension bar 280 is also shown locked into place, in its extended position, via lock pin 65.

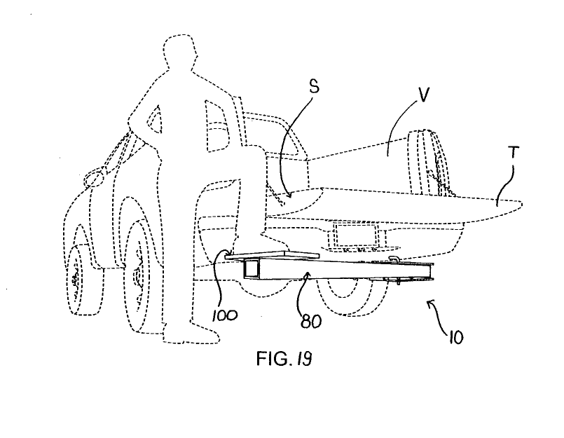

As best illustrated in FIG. 18, alternate embodiment device 10 is shown attached to the underside of standard factory bumper step BS of vehicle V, wherein tailgate T is shown in a raised position. As depicted, extension bar 280 is in a retracted position, thus permitting a user of device 10 to step from the ground onto step 100, onto factory bumper step BS, and thereafter, over tailgate T and into the vehicle's truck bed, thus permitting access thereto from side S of vehicle V. Extension bar 280 is also shown locked into place, in its retracted position, via lock pin 65.

Referring now more specifically to FIG. 19, illustrated therein is an alternate embodiment of device 10, wherein the alternate embodiment of FIG. 19 is substantially equivalent in form and function to that of the alternate embodiment detailed and illustrated in FIGS. 1-6 except as hereinafter specifically referenced. Specifically, the embodiment of FIG. 19 preferably illustrates an elongated extension bar 80, thus permitting access to contents within the truck bed from the side S of the truck bed when tailgate T is in a lowered or open position. Such a configuration and functional design permits overall user accessibility to the contents within a vehicle's truck bed when the vehicle's tailgate is either in a raised or lowered position, and from either directly behind the vehicle or from the side of the vehicle's truck bed, irrespective of the tailgate position.

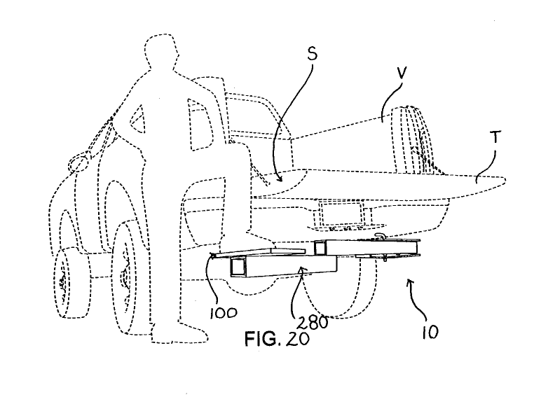

Referring now more specifically to FIG. 20, illustrated therein is an alternate embodiment of device 10, wherein the alternate embodiment of FIG. 20 is substantially equivalent in form and function to that of the alternate embodiment detailed and illustrated in FIGS. 7-12 except as hereinafter specifically referenced. Specifically, the embodiment of FIG. 20 preferably illustrates an elongated extension bar 280, thus permitting access to contents within the truck bed from the side S of the truck bed when tailgate T is in a lowered or open position. Such a configuration and functional design permits overall user accessibility to the contents within a vehicle's truck bed when the vehicle's tailgate is either in a raised or lowered position, and from either directly behind the vehicle or from the side of the vehicle's truck bed, irrespective of the tailgate position.

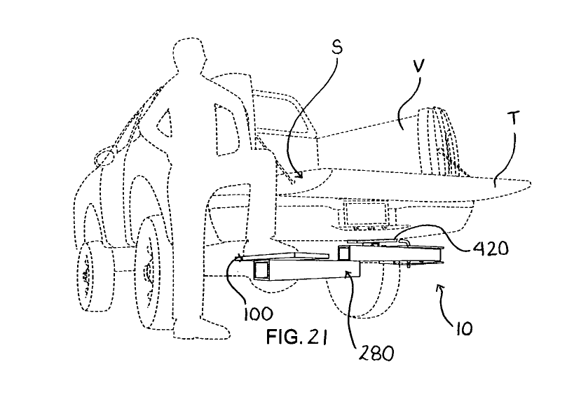

Referring now more specifically to FIG. 21, illustrated therein is an alternate embodiment of device 10, wherein the alternate embodiment of FIG. 21 is substantially equivalent in form and function to that of the alternate embodiment detailed and illustrated in FIGS. 13-18 except as hereinafter specifically referenced. Specifically, the embodiment of FIG. 21 preferably illustrates an elongated extension bar 280, thus permitting access to contents within the truck bed from the side S of the truck bed when tailgate T is in a lowered or open position. Such a configuration and functional design permits overall user accessibility to the contents within a vehicle's truck bed when the vehicle's tailgate is either in a raised or lowered position, and from either directly behind the vehicle or from the side of the vehicle's truck bed, irrespective of the tailgate position.

It is contemplated in an alternate embodiment that the preferred and alternate embodiments of device 10 could be modified to permit extension bar 80 and/or 280 to swivel within a 180 degree range when mounted to the rear of a vehicle.

It is contemplated in an alternate embodiment that extension bar 80 and/or 280 could possess selectably lockable telescopic capabilities to ensure accessibility of step 100 at any position.

It is contemplated in an alternate embodiment that the preferred and alternate embodiments of device 10 could be modified to permit user-selectable lockable positioning of extension bar 80 and/or 280 at any user-specified pivotal position.

It is contemplated in an alternate embodiment that the preferred and alternate embodiments of device 10 could be manufactured to any size and/or shape to best suit the vehicle.

It is contemplated in an alternate embodiment that the preferred and alternate embodiments of device 10 could be modified to permit attachment to any type of vehicle.

It is contemplated in an alternate embodiment that step 100 could be lockingly pivotable on extension bar 80 and/or 280 to permit step 100 to be folded away when extension bar 80 and/or 280 is in a retracted position.

It is contemplated in an alternate embodiment that lock pin 65 could be replaced by fixedly-positioned spring-loaded lock pins for the locking of extension bar 80 and/or 280 in an extended and/or retracted position.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A vehicle tailgate step, comprising:
means for mounting said vehicle tailgate step to a vehicle;
at least one support depending from said mounting means; and,
means for extending at least one step past an open tailgate of the vehicle, said extending means in pivotal communication with said at least one support.

2. The vehicle tailgate step of claim 1, wherein said mounting means is a tube dimensioned to be received by a standard receiver-style hitch.

3. The vehicle tailgate step of claim 1, wherein said mounting means is a mounting plate adapted to be received and secured to a bumper step and hitch-ball receiver assembly.

4. The vehicle tailgate step of claim 1, wherein said at least one support comprises an upper plate adjoined with a lower plate, and wherein said extending means is in pivotal communication therebetween.

5. The vehicle tailgate step of claim 4, wherein said upper plate and said lower plate possess throughholes adapted to be aligned with throughholes formed through said extending means, wherein alignment of said throughholes of said upper plate and said lower plate with said throughholes of said extending means permit a lock pin to be extended therethrough to lock said extending means in a user-selected pivoted positioned.

6. The vehicle tailgate step of claim 1, wherein said extending means comprises at least one straight extension bar, said at least one bar comprising at least one step in contact therewith.

7. The vehicle tailgate step of claim 1, wherein said means for extending is at least one extension bar, said at least one extension bar having a downwardly-directed goose-neck shape, and wherein said at least one extension bar comprises at least one step in contact therewith.

8. The vehicle tailgate step of claim 1, wherein said extending means comprises at least one telescopic extension bar, said at least one telescopic extension bar comprising at least one step in contact therewith.

9. The vehicle tailgate step of claim 1, wherein said extending means is lockably pivotable from a retracted position to an extended position.

10. A vehicle tailgate step, comprising:
means for mounting said vehicle tailgate step to a vehicle;
at least one support depending from said mounting means; and,
an extension bar for extending at least one step past an open tailgate of the vehicle, said extension bar in pivotal communication with said at least one support.

11. The vehicle tailgate step of claim 10, wherein said mounting means is a tube dimensioned to be received by a standard receiver-style hitch.

12. The vehicle tailgate step of claim 10, wherein said mounting means is a mounting plate dimensioned to be received and secured to a bumper step and hitch-ball receiver assembly.

13. The vehicle tailgate step of claim 10, wherein said at least one support comprises an upper plate adjoined with a lower plate, and wherein said extension bar is in pivotal communication therebetween.

14. The vehicle tailgate step of claim 13, wherein said upper plate and said lower plate possess throughholes adapted to be aligned with throughholes formed through said extension bar, wherein alignment of said throughholes of said upper plate and said lower plate with said throughholes of said extension bar permit a lock pin to be extended therethrough to lock said extension bar in a user-specified pivoted positioned.

15. The vehicle tailgate step of claim 10, wherein said extension bar is substantially straight and comprises at least one step in contact therewith.

16. The vehicle tailgate step of claim 10, wherein said extension bar possesses a downwardly-directed goose-neck shape, and wherein said extension bar comprises at least one step in contact therewith.

17. The vehicle tailgate step of claim 10, wherein said extension bar is lockably pivotable from a retracted position to an extended position.

18. A vehicle tailgate step, comprising:
means for mounting said vehicle tailgate step to a vehicle;
at least one support depending from said mounting means, said at least one support comprising an upper plate adjoined with a lower plate; and,
an extension bar for extending at least one step past an open tailgate of the vehicle, said extension bar in pivotal communication between said upper plate and said lower plate of said at least one support.

19. The vehicle tailgate step of claim 18, wherein said mounting means is a tube dimensioned to be received by a standard receiver-style hitch.

20. The vehicle tailgate step of claim 18, wherein said mounting means is a mounting plate dimensioned to be received and secured to a bumper step and hitch-ball receiver assembly.

21. The vehicle tailgate step of claim 18, wherein said upper plate and said lower plate of said at least one support possess throughholes adapted to be aligned with throughholes formed through said extension bar, wherein alignment of said throughholes of said upper plate and said lower plate with said throughholes of said extension bar permit a lock pin to be extended therethrough to lock said extension bar in a user-specified pivoted positioned.

22. The vehicle tailgate step of claim 18, wherein said extension bar is substantially straight and comprises at least one step in contact therewith.

23. The vehicle tailgate step of claim 18, wherein said extension bar possesses a downwardly-directed goose-neck shape, and wherein said extension bar comprises at least one step in contact therewith.

24. The vehicle tailgate step of claim 18, wherein said extension bar is lockably pivotable from a retracted position to an extended position.
